(19) United States
(12) Patent Application Publication
(10) Pub. No.: US 2025/0155136 A1
(43) Pub. Date: May 15, 2025

(54) METHOD FOR PRODUCING A PANEL-SHAPED AREA HEATING ELEMENT AND AN AREA HEATING ELEMENT PRODUCED ACCORDING TO THIS METHOD, AND WALL PORTION OR CEILING PORTION OR FLOOR PORTION COMPRISING THE AREA HEATING ELEMENT

(71) Applicant: SAINT-GOBAIN PLACO, Courbevoie (FR)

(72) Inventors: Klaus Schmalbuch, Weinheim (DE); Thomas Schilling, Schönborn (DE)

(21) Appl. No.: 18/836,419

(22) PCT Filed: May 17, 2023
(86) PCT No.: PCT/EP2023/063292

§ 371 Date: Aug. 7, 2024

(30) Foreign Application Priority Data
May 18, 2022 (DE) 10 2022 112 515.7

(51) Int. Cl. F24D 13/02; B28B 19/00; B32B 13/08

(52) U.S. Cl. CPC F24D 13/02; B28B 19/0092; B32B 13/08; B32B 2250/03; B32B 2250/40; B32B 2262/106; B32B 2307/202; B32B 2307/718; B32B 2307/724; B32B 2457/00; B32B 2607/00

(57) ABSTRACT

The invention relates to a method for producing a panel-shaped area heating element (1) comprising the steps: a) providing at least one first paper/cardboard layer (2); b) applying a gypsum slurry layer (3) on a free side of the first paper/cardboard layer (2); c) molding the gypsum slurry layer (3) to a gypsum slurry layer (3) with a uniform layer thickness (t); d) applying at least one second paper/cardboard layer (5) on a free surface of the gypsum slurry layer (4); e) curing the gypsum slurry layer (3) to a gypsum layer (30); f) cutting into individual panels and drying the individual panels; g) wherein a paper/cardboard structure (12) which is electroconductive at least after curing the gypsum slurry layer (3) is used for forming the at least one first and/or second paper/cardboard layer (2; 5). It also relates to an area heating element produced according to the method and a wall portion or ceiling portion or floor

### BACKGROUND OF THE INVENTION

The invention relates to a method for producing a panel-shaped area heating element according to the preamble of claim 1, and an area heating element produced according to this method, as well as a wall portion or ceiling portion or floor portion comprising the area heating element.

The European Patent Document EP 2 770 104 B1 discloses an electrically conducting paper structure. Using such paper for creating area heaters, for example, wall radiators, is known from this document. In addition it is indicated that such paper may be laminated onto stone, textiles or other materials.

The US 2020/0354955 A1 discloses conductive paper for producing an electroactive surface as well as a construction element equipped with this paper and a production method for producing the construction element. It is proposed that the electroconductive paper includes carbon fibers. Regarding the method it is proposed to produce the paper first, then dry the paper and apply the dried paper to one or more surfaces of the construction element. It is furthermore proposed to use the thus resulting construction element in order to electromagnetically shield a room or as an electrode for capacitive controls.

### SUMMARY OF THE INVENTION

The object of the invention is to provide a novel use for such an electrically conducting paper structure. The object of the invention is particularly to provide a method by means of which a panel-shaped area heating element may be produced cost-efficiently and in large quantities. Furthermore, it is an object of the invention to provide a corresponding area heating element. In addition, an object of the invention is to provide a wall portion, a ceiling portion or a floor portion comprising the area heating element produced with this method.

With respect to the method, the above object is achieved by a method having the features of claim 1. Advantageous embodiments are indicated in the sub-claims dependent on claim 1.

With respect to the area heating element, the above object is achieved by an area heating element having the features of claim 11.

With respect to the wall portion, the floor portion and the ceiling portion, the above object is achieved by a wall portion, a ceiling portion, a floor portion having the features of claim 13.

A method according to the present invention for producing a panel-shaped area heating element comprises the following steps:
a) providing a first paper/cardboard layer;
b) applying a gypsum slurry layer on a free side of the first paper/cardboard layer;
c) molding the gypsum slurry layer to a gypsum slurry layer with a uniform layer thickness (t);
d) applying at least one second paper/cardboard layer on a free surface of the gypsum slurry layer;
e) curing the gypsum slurry layer to a gypsum layer;
f) cutting into individual panels and drying the individual panels;
g) characterized in that a paper/cardboard structure which is electroconductive at least after curing the gypsum slurry layer is used for forming the at least one first and/or second paper/cardboard layer.

The method according to the present invention enables simple production of a panel-type area heating element which may be used directly as a construction panel, similar to a gypsum plasterboard panel, for building walls, wall portions, ceilings, ceiling portions, ceiling coverings or floor portions or flooring. Common, previously known fastening techniques or construction techniques of such drywall constructions may be readily applied also to the area heating element produced according to method according the present invention. As a result, corresponding drywall constructions may be created which have an electroconductive layer immediately after construction which may be used for heating purposes, particularly, for example, for area heating purposes. An additional or later application of area heating elements, such as, for example, wire fabric or electroconductive planar structures of any other type, may be dispensed with. The method according to the present invention may be integrated very easily into an existing production line for gypsum plasterboard panels such that, by replacing at least one of the paper/cardboard layers with a layer of an electroconductive paper/cardboard structure, an existing production line for the manufacturing of conventional gypsum plasterboard panels may be simply converted or expanded for the production of area heating elements according to the present invention in a particularly easy manner.

In a particular embodiment of the method according to the present invention a paper/cardboard layer having at least one or more features selected from the following features is used as the at least one paper/cardboard layer of the electroconductive paper/cardboard structure:
the electroconductive paper/cardboard structure has at least one of carbon fibers and graphite components;
the electroconductive paper/cardboard structure has an area-related mass of 75-120 g/m², particularly of 75-80 g/m²;
the electroconductive paper/cardboard structure has an air permeability of 90-100 l/m², particularly 95 l/m²s in accordance with ISO 9237;
at least before being brought into direct or indirect contact with the gypsum slurry layer, the electroconductive paper/cardboard structure has an electrical resistivity of 10⁻⁵ to 10⁻² Ωm, preferably of 10⁻² Ωm to 10⁻² Ωm, particularly of 10⁻³ to 10⁻² Ωm.

Using such a paper/cardboard structure for forming the at least one electroconductive paper/cardboard layer has proven to be particularly feasible for an integration into an existing production facility for gypsum plasterboard panels. Within the framework of the invention, particularly use of an electroconductive paper/cardboard structure having the electrical resistivity values indicated above was discovered, with these values applying particularly to the electroconductive paper/cardboard structure before it comes into contact with the gypsum slurry directly in the form of a single-layer paper/cardboard layer or directly or indirectly in the form of a multi-layer paper/cardboard layer. It was furthermore discovered that the electrical resistivity of the starting paper/cardboard structure, before being brought in contact with the gypsum slurry layer, changes, particularly increases, over the course of the production of the area heating element. One possible explanation may be that gypsum crystals “grow into” pores of the electroconductive paper/cardboard structure while the gypsum slurry layer cures and thus change, particularly increase, the electrical resistivity of the paper/cardboard structure as it is after curing and subsequent drying. Here it was observed that the effect described above of the resistivity increasing becomes greater in the case of direct contact between the electroconductive paper/cardboard structure and the gypsum slurry layer than in the case of indirect contact between the electroconductive paper/cardboard structure and the gypsum slurry layer. Indirect contact is the case, for example, when a multi-layer paper/cardboard layer is used and when an additional, for example, electrically nonconductive base layer is provided between the electroconductive paper/cardboard structure of the multi-layer paper/cardboard layer and the gypsum slurry layer.

In another embodiment, the electroconductive paper/cardboard layer is formed as a single layer of the electroconductive paper/cardboard structure or the electroconductive paper/cardboard layer is formed as multiple layers as a composite layer having at least one, preferably nonconductive, base layer and at least one layer of the electroconductive paper/cardboard structure.

In the first alternative of this embodiment, a particularly material-saving configuration is enabled. In the second alternative of this embodiment, using a multi-layered composite layer makes it possible to increase the mechanical load-bearing capacity of the electroconductive paper/cardboard layer. In the case of an external arrangement of the electroconductive paper/cardboard structure where it faces away from the gypsum slurry, a base layer prevents a direct moistening of the electroconductive paper/cardboard structure with a gypsum slurry that is still liquid. In this way, a negative influence on the electrical properties of the electroconductive paper/cardboard structure due to the crystallization of gypsum crystals in the paper/cardboard structure during the drying process is at least decreased, possibly even prevented. Although this effect is not suppressed in the case of the reverse arrangement of the conductive paper/cardboard structure, where it faces the gypsum slurry, the conductive paper/cardboard structure is advantageously protected by a base layer against any mechanical damage.

The electroconductive paper/cardboard layer, particularly in the embodiment design as a composite layer, appropriately protrudes laterally at the periphery beyond the gypsum slurry layer as well and is folded over the free lateral leading edges of the gypsum layer such that it surrounds or encompasses them before, during or after the curing step (step e)).

Preparing lateral leading edges of the area heating elements that may be produced with the method according to the present invention, for example, for contacting purposes may thus be achieved in a simple manner. Where applicable, an undesirably visible contacting area on a flat side of the area heating element may thereby be prevented. Particularly in the embodiment design as a composite layer it is possible to carry out the surrounding or encompassing of the lateral edges, where applicable, merely with the base layer such that the electroconductive paper/cardboard structure is not subjected to folding around the edge areas and is thus especially preserved mechanically.

In an advantageous embodiment of the method according to the present invention, the electroconductive paper/cardboard layer has contacting mechanisms or contacting regions which are configured, formed and provided to be arranged on the side of the area heating element on which the paper/cardboard layer is arranged or to be arranged on a reverse side of the area heating element which is opposite the side of the paper/cardboard layer.

Such an arrangement leads to good accessibility of the contact areas after the construction of drywall constructions by means of such area heating elements, which simplifies the electrical connection of the area heating elements.

In an appropriate embodiment design of the method according to the present invention, the reverse side of the area heating element is clear of any electroconductive paper/cardboard structure.

The risk of a short circuit is thus decreased when, for example, the area heating element is to be applied on a conventional drywall carrier structure consisting of metal beam/post elements. Any additional effort for electrical insulation, where applicably, may thus be dispensed with.

Furthermore, it may be advantageous that the paper/cardboard layer is arranged to extend merely across a partial area of a lateral leading edge of the area heating element, particularly of the gypsum layer, when seen in a thickness direction (DR) of the area heating element.

In this way, on the one hand, a contacting possibility may be created in the area of the lateral leading edges of the area heating element and, on the other hand, risk of a short circuit due to an arrangement of the electroconductive paper/cardboard structure on the rear side may be reliably prevented. This advantage is guaranteed by the mentioned partial folding of the electroconductive paper/cardboard layer across only a part of the lateral leading edges.

It is furthermore appropriate that, in the case where the composite layer is used, the base layer is formed of an electrically nonconductive paper/cardboard structure.

This measure contributes, on the one hand, to increasing the mechanical strength of the electroconductive paper/cardboard structure, particularly in a moist/wet state during production. On the other hand, by providing a conventional, i.e., electrically nonconductive paper/cardboard layer as a base layer, a known and proven adhesive characteristic of the paper/cardboard layer on the gypsum slurry layer or the gypsum layer may be utilized.

In addition, it may be appropriate in the case where the composite layer is used that merely the base layer in the area of the lateral leading edges of the gypsum layer protrudes laterally by a small extend beyond the electroconductive paper/cardboard structure in a width direction (BR) vertically to the running direction (LR) of the paper/cardboard layer and merely the base layer is folded over the lateral leading edges of the gypsum layer in an encompassing manner.

This measure ensures that the electroconductive paper/cardboard layer is not subjected to any folding or bending which might undesirably lead to locally increased resistance and therefore to undesired local overheating during heating operation.

The invention also relates to an area heating element produced with the method according to the present invention.

The panel-shaped area heating element is preferably produced as an area heating element finished product with an electrical resistivity of 5·10−5 to 2·10−2 Ωm, preferably of 10−3 Ωm to 2·10−2 Ωm, particularly 9·10−3 to 2·10−2 Ωm.

Such an area heating element finished product may be produced taking the effect of change mentioned above into consideration, particularly the increase of the electrical resistivity of the electroconductive starting paper/cardboard structure during curing and drying of the gypsum slurry layer. The effect mentioned above of gypsum crystals “growing into” the open-pored structure of the electroconductive paper/cardboard structure is systematically utilized here in order to obtain a desirable finished product with desirable properties, particularly with desirable electrical resistivity values.

The advantages mentioned above with respect to the production method may accordingly also be achieved by means of such an area heating element.

In addition, the invention also includes at least a wall portion or a ceiling portion or a floor portion comprising an area heating element according to the present invention.

The advantages mentioned above may analogously be utilized correspondingly in the construction and/or operation of such a portion according to the present invention.

### BRIEF DESCRIPTION OF THE DRAWINGS

In the following, the method according to the present invention is explained in greater detail as an example based on the drawings. They show:

FIG. 1: a perspective schematic view of a production facility by means of which the method according to the present invention may be executed;

FIGS. 2a to 2d: perspective views of different embodiments of lateral leading edge areas of an area heating element produced or to be produced with the method according to the present invention.

### DETAILED DESCRIPTION OF EMBODIMENTS OF THE INVENTION

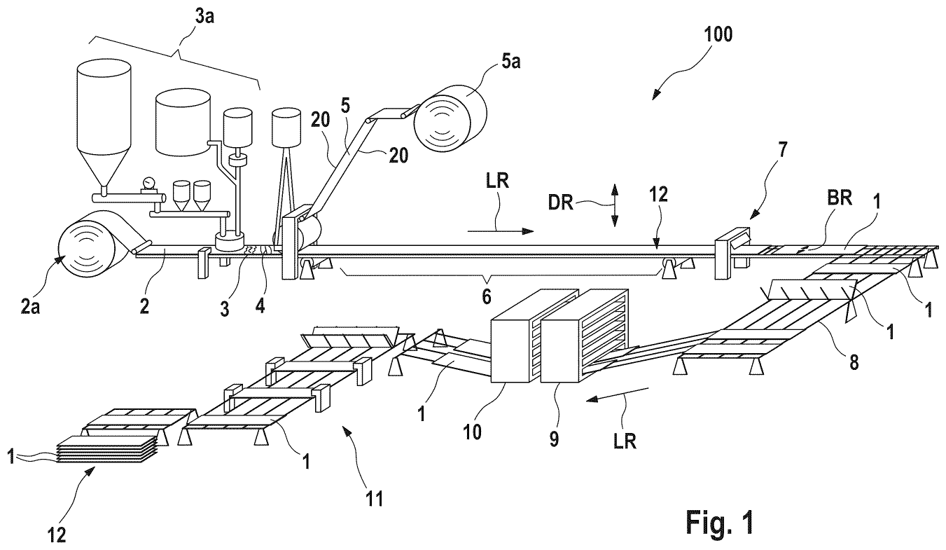

FIG. 1 schematically shows an inherently known production facility 100 by means of which the method of manufacturing according to the present invention of an area heating element 1 may be performed. For the further description, a running direction LR and a width direction BR are defined, with the running direction LR corresponding to a longitudinal direction of the area heating element 1. The width direction BR is vertical to the running direction LR in a plane of the area heating element 1.

First, the first paper/cardboard layer 2 is provided by a paper roll 2a. During a pre-molding, a trough-shaped cross-section design of the first paper/cardboard layer 2 is produced which serves to receive, by means of a gypsum slurry 3b which is produced in a processing facility 3a not described in more detail, the gypsum slurry layer 3 downstream in running direction, which is applied on a free upper surface of preformed first paper/cardboard layer 2.

In what is known as an “extruder” 4, the gypsum is spread, and the panel is molded. In the process, the edges of the first paper/cardboard layer are folded and glued in the overlapping area to a second paper/cardboard layer 5 rolled off a paper roll 5a. In this step, the panel is molded, i.e., the edges are formed and the uniform thickness t in the thickness direction DR vertical to the plane of the first paper/cardboard layer 2 is set. The moist gypsum slurry layer 3 is cured or hardened along a drying section 6. Subsequent to the curing/hardening, cutting of individual area heating elements 1 may take place in a cutting station 7. The cut area heating elements 1 are supplied via further conveying mechanisms 8 to a multizone drying station 9, 10. Loading stations 11 for creating stacks 12 of area heating elements 1 may follow.

In order to realize the method according to the present invention an electroconductive paper/cardboard layer 2, 5 may be stored either on the paper roll 2a or on the paper roll 5a or on both paper rolls 2a, 5a.

The at least one electroconductive paper/cardboard layer 2, 5 is made of an electroconductive paper/cardboard structure 12 provided with graphite components and/or conducting fiber components, for example, carbon fiber components, in order to achieve electric conductivity.

Such a paper/cardboard structure 12 has, for example, features listed below either individually or in any combination:
the electroconductive paper/cardboard structure 12 has at least one of carbon fibers and graphite components;
the electroconductive paper/cardboard structure 12 is formed as a single layer;
the electroconductive paper/cardboard layer 5 is formed of the electroconductive paper/cardboard structure 12 in multiple layers as a composite layer 13 having at least one base layer 14 and at least one paper/cardboard layer 2, 5;
the electroconductive paper/cardboard structure 12 has an area-related mass of 75-120 g/m², particularly of 75-80 g/m²;
the electroconductive paper/cardboard structure 12 has a thickness of 200-350 μm, particularly of 200-250 μm;
at least before being brought into direct or indirect contact with the gypsum slurry layer, the electroconductive paper/cardboard structure (12) has an electrical resistivity of 10⁻⁵ to 10⁻² Ωm, preferably of 10⁻⁴ Ωm to 10⁻² Ωm, particularly of 10⁻³ to 10⁻² Ωm.

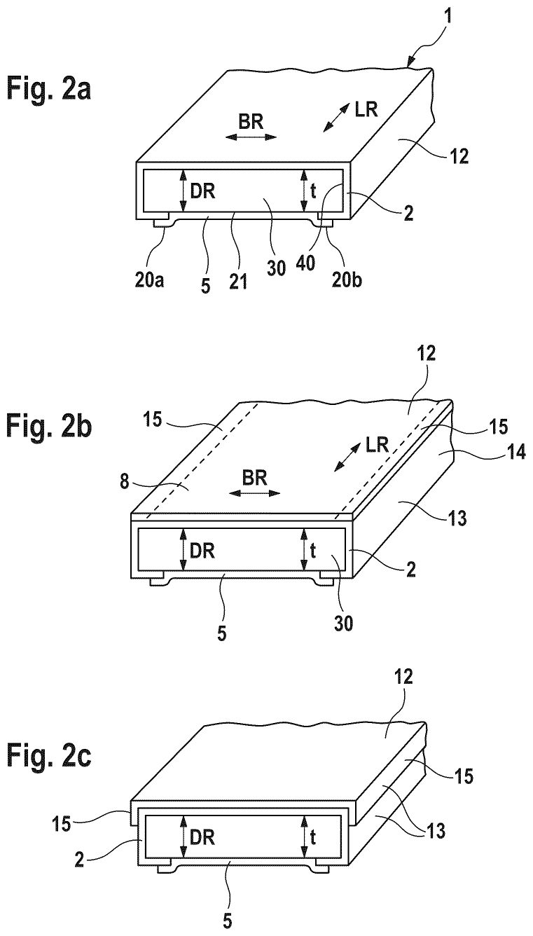

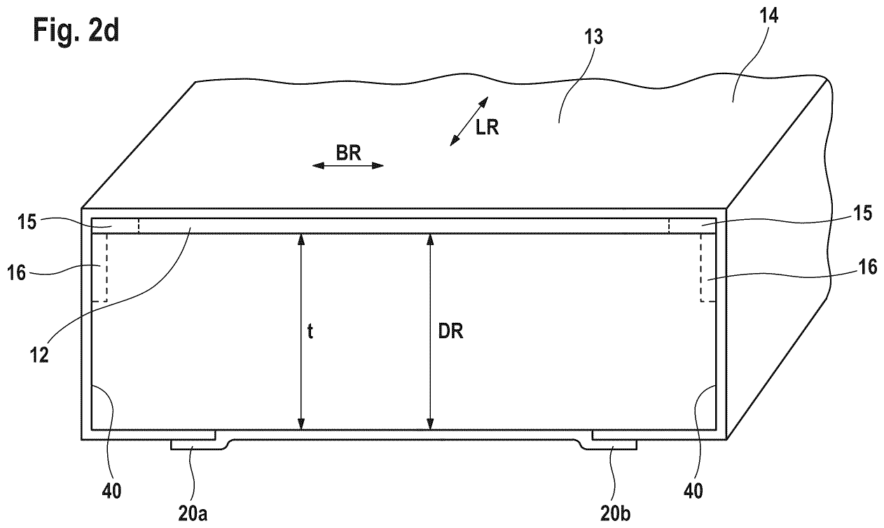

In the following, a plurality of different embodiments of area heating elements 1 that may be produced with the method according to the present invention are explained as an example in greater detail with reference to FIGS. 2a to 2d. The exemplary embodiments according to FIGS. 2a to 2d each have a gypsum layer 30, a first paper/cardboard layer 2 and a second paper/cardboard layer 5. In the embodiments shown, the second paper/cardboard layer 5 is formed of an electrically nonconductive paper/cardboard structure. In this context “electrically non-conducting” means that in a cured, particularly a dry state of the area heating element 1, particularly of the gypsum layer 30, the electrically nonconductive paper/cardboard layer has no noteworthy electrical conductivity, particularly an electric resistance of more than 10 kOhm/15 mm.

In the exemplary embodiments according to FIGS. 2a to 2d the first paper/cardboard layer 2 is formed of the electroconductive paper/cardboard structure 12 as the electrically conducting paper/cardboard layer. In the exemplary embodiment according to FIG. 2a the second paper/cardboard layer 5 is formed as a single layer. In the embodiments according to FIGS. 2a to 2d the electroconductive first paper/cardboard layer is formed of the electroconductive paper/cardboard structure 12 as a composite layer 13 with a base layer 14 and a paper/cardboard layer 2.

Furthermore, the exemplary embodiments according to FIGS. 2a to 2d emphasize different designs in the area of lateral leading edges 40 of the area heating elements 1 and the gypsum layer 30.

In the embodiment according to FIG. 2a the electroconductive first paper/cardboard layer 2 bends over the lateral leading edges 40 und is glued to the second paper/cardboard layer 5 on the bottom or rear side in two overlapping areas 20a and 20b using an adhesive that is not shown. In the area 21 not covered by the first paper/cardboard layer 2, the second paper/cardboard layer 5 lies directly against the gypsum layer 30. Needless to say, in this exemplary embodiment it is in principle possible to form the first paper/cardboard layer 2 as not electrically conducting and instead form the second paper/cardboard layer 5 of the electroconductive paper/cardboard structure 12.

In a variation of the embodiments according to FIG. 2a, the second paper/cardboard layer 5 may also be cut such that this second paper/cardboard layer 5 is flush with the lateral leading edges 40. This embodiment is not shown in the figures. With respect to the rest, the embodiment described above corresponds to the embodiment according to FIG. 2a with regard to the layer configuration.

The embodiments according to FIGS. 2b to 2d have, as a cover layer on the gypsum layer 30, the composite layer 13 that has a base layer 14 and a layer of the electroconductive paper/cardboard structure 12, that is, of a first paper/cardboard layer 2. The base layer 14 and the first paper/cardboard layer 2 are here preferably stored as a composite on the paper roll 2a such that the method according to the present invention may be carried out selectively with a single-layered or a two-layered embodiment of the electroconductive paper/cardboard layer without needing to perform any complex modifications of the facility 100, with the exception of providing a suitably equipped paper roll 2a. Merely in the case of the “inverted” single-layered design according to FIG. 2a, the electroconductive paper/cardboard layer must be provided on the paper roll 5a and the nonconductive paper/cardboard layer must be provided on the paper roll 2a.

The composite layer 13 is formed in the embodiment according to FIG. 2a such that the base layer 14 bends over the lateral leading edge 40 of the gypsum layer 30 and the layer of the electroconductive paper/cardboard structure 12 is arranged externally. The layer of electroconductive paper/cardboard structure 12 is cut such here that it does not protrude on both sides beyond the lateral leading edges 40 of the gypsum layer 30 and is essentially coextensive with the upper surface of the area heating element 1. As an alternative the layer of electroconductive paper/cardboard structure 12 may be cut such that an edge trim 15 is not covered preferably at both lateral edges 40.

The embodiment according to FIG. 2c differs from the embodiment according to FIG. 2b in that the layer of electroconductive paper/cardboard structure 12 is cut such that it is folded around the lateral edges 40 and partially covers them. Contacting possibilities are thus created in the area of the lateral leading edges of the area heating element and contacting in the area of the surface 8 may be dispensed with.

FIG. 2d shows an embodiment in which the composite layer 13, that is, the base layer 14 and the electroconductive layer of electroconductive paper/cardboard structure 12 arranged thereon, are arranged in reverse order with respect to the embodiment of FIG. 2b. The layer of the electroconductive paper/cardboard structure 12 is cut such that it extends from a lateral edge 40 to the opposite lateral edge 40. The layer of the electroconductive paper/cardboard structure 12 lies against the gypsum layer 30 and is covered externally by the base layer 14, with the electroconductive paper/cardboard structure 12 being protected by the base layer 14 against mechanical effects. Needless to say, it is possible, analogously to the embodiments shown in FIGS. 2b and 2c, to cut the layer of an electroconductive paper/cardboard structure 12 such that an edge trim 15 that is preferably not covered on both sides by the layer 12 or that a partially internal overlap 16 of the lateral edges 40 is created.

The embodiments according to FIGS. 2a and 2c in particular as well as, generally said, embodiments in which a layer of electroconductive paper/cardboard structure 12 is provided lying on the lateral leading edge 40 or is provided including the same may in principle be suitable for adjacently arranged area heating elements 1 which, for example, create a wall portion and/or a floor portion and/or a ceiling portion, being electrically contacted by one another in the peripheral areas of the lateral leading edges 40 through contact via the electroconductive paper/cardboard layer. Such contacting may, where applicable, be improved with respect to reliability, where applicable, by means of an intermediate layer of additional contacting elements (not shown) in the area of adjoining area heating elements 1.

1. A method for producing a panel-shaped area heating element (1) comprising the steps:
a) providing at least one first paper/cardboard layer (2);
b) applying a gypsum slurry layer (3) on a free side of the first paper/cardboard layer (2);
c) molding the gypsum slurry layer (3) to a gypsum slurry layer (3) with a uniform layer thickness (t);
d) applying at least one second paper/cardboard layer (5) on a free surface of the gypsum slurry layer (4);
e) curing the gypsum slurry layer (3) to a gypsum layer (30);
f) cutting into individual panels and drying the individual panels;
g) characterized in that a paper/cardboard structure (12) which is electroconductive at least after curing the gypsum slurry layer (3) is used for forming the at least one first and/or second paper/cardboard layer (2; 5).

2. The method according to claim 1, characterized in that a paper/cardboard layer (2; 5) that has at least one or more features selected from the following features is used as the at least one paper/cardboard layer (2; 5) of the electroconductive paper/cardboard structure (12):
the electroconductive paper/cardboard structure (12) has at least one of carbon fibers and graphite components;
the electroconductive paper/cardboard structure (12) has an area-related mass of 75-120 g/m², particularly of 75-80 g/m²;
the electroconductive paper/cardboard structure (12) has an air permeability of 90-100 l/m², particularly 95 l/m²s in accordance with ISO 9237;
at least before being brought into direct or indirect contact with the gypsum slurry layer, the electroconductive paper/cardboard structure (12) has an electrical resistivity of 10⁻⁵ to 10⁻² Ωm, preferably of 10⁻⁴ Ωm to 10⁻² Ωm, particularly of 10⁻³ to 10⁻² Ωm.

3. The method according to claim 1, characterized in that the electroconductive paper/cardboard layer (2; 5) is formed of the electroconductive paper/cardboard structure (12) as a single layer or the electroconductive paper/cardboard layer (2; 5) is formed in multiple layers as a composite layer (13) having at least one, preferably nonconductive, base layer (14) and at least one layer (14a) of the electroconductive paper/cardboard structure (12).

4. The method according to claim 1, characterized in that the electroconductive paper/cardboard layer (2; 5), particularly in the embodiment design as a composite layer, appropriately protrudes laterally in the periphery beyond the gypsum slurry layer (3) and is folded over free lateral leading edges (40) of the gypsum layer (30) such that it surrounds or encompasses them before, during or after the curing step (step e)).

5. The method according to claim 1, characterized in that the electroconductive paper/cardboard layer (2; 5) has contacting mechanisms or contacting regions which are configured, formed and provided to be arranged on the side of the area heating element (1) on which the electroconductive paper/cardboard layer (2; 5) is arranged or to be arranged on a reverse side of the area heating element (1) which is opposite the side of the paper/cardboard layer (2; 5).

6. The method according to claim 5, characterized in that the reverse side of the area heating element (1) is kept clear of an electroconductive paper/cardboard structure (12).

7. The method according to claim 4, characterized in that the electroconductive paper/cardboard layer (2; 5) is arranged to extend merely across a partial area of a lateral leading edge (40) of the area heating element (1), particularly the gypsum layer (30), when seen in a thickness direction (DR) of the area heating element (1).

8. Method according to claim 3, characterized in that, in the case where the composite layer (13) is used, the base layer (14) is formed of an electrically nonconductive paper/cardboard structure.

9. The method according to claim 3, characterized in that, in the case where the composite layer (13) is used, merely the base layer (14) in the area of the lateral leading edges (40) of the composite layer (13) protrudes laterally in a width direction (BR) vertical to a running direction (LR) of the composite layer (13) by a small extend beyond the electroconductive paper/cardboard structure (12) and merely the base layer (14) is folded over the lateral leading edges (40) of the gypsum layer (30) in an encompassing manner.

10. The method according to claim 1, characterized in that the panel-shaped area heating element (1) is produced as an area heating element finished product with an electrical resistivity of 5·10−5 to 2·10−2 Ωm, preferably of 10−3 Ωm to 2·10−2 Ωm, particularly 9·10−3 to 2·10−2 Ωm.

11. An area heating element produced according to the method of claim 1.

12. The area heating element according to claim 11, characterized in that the panel-shaped area heating element (1) is produced as an area heating element finished product having an electrical resistivity of 5·10−5 to 2·10−2 Ωm, preferably of 10−3 Ωm to 2·10−2 Ωm, particularly 9·10−3 to 2·10−2 Ω-m.
